(19) United States
(12) Patent Application Publication
(10) Pub. No.: US 2023/0143364 A1
(43) Pub. Date: May 11, 2023

(54) SYSTEM AND METHOD OF BUILDING CONTACT CENTER AGENT DESKTOPS PROVIDING SIMULTANEOUS ACCESS TO MULTIPLE ACD SYSTEMS IN A SINGLE SESSION

(71) Applicant: Amit Gandhi, Alpharetta, GA (US)

(72) Inventor: Amit Gandhi, Alpharetta, GA (US)

(73) Assignee: NovelVox NA Inc, Bethesda, MD (US)

(21) Appl. No.: 17/519,716

(22) Filed: Nov. 5, 2021

(51) Int. Cl. H04M 3/51; H04M 3/523

(52) U.S. Cl. CPC H04M 3/5191; H04M 3/5237

(57) ABSTRACT

A system for providing call center agent desktops is provided comprising a computer and an application executing on the computer. The system receives a request from a client device for a desktop image and accesses a stored desktop image for the client device. The system also enables links in the stored image to at least two ACD systems and provides access to the image to the client device. The client device is used by a call center agent responding to incoming calls via desktop ACD access provided by the activated links. The at least two ACD systems are provided by unrelated vendors. Access to the at least two ACD systems is provided by at least one adapter executing on the computer, the at least one adapter created from at least two application programming interfaces (API) furnished by providers of the at least two ACD systems.

### FIELD OF THE DISCLOSURE

The present disclosure is in the field of contact center management. More particularly, the present disclosure provides systems and methods of constructing agent desktop images from a studio application that enables contact center agents to access multiple ACD systems from within a single browser session hosting a customized desktop configuration.

### BACKGROUND

Persons phoning into call centers and contact centers do not want to wait while an agent must switch from one screen to another. When an agent must move between multiple screens during a customer call, efficiency and call resolution time suffer and the probability of error increases. Customer satisfaction inevitably suffers.

An integrated agent desktop not provided in the prior art could reduce the need for screen switching by bringing information from multiple applications under a single umbrella in a non-intrusive manner. Such an integrated desktop may provide a 360-degree view of the customer information needed to personalize agent interactions with callers.

Improved flow and availability of information make it possible for the agent to serve a customer in a more professional manner, yielding positive results for the customer, such as faster resolutions in a single call and no unnecessary transfers or holds. Customer experience may be improved, and long-term customer loyalty may be more likely.

### BRIEF DESCRIPTION OF THE FIGURES

FIG. 1 is a block diagram of a system of building contact center agent desktops providing simultaneous access to multiple ACD systems in a single session according to an embodiment of the present disclosure.

### DETAILED DESCRIPTION

Systems and methods described herein provide for remotely building and customizing contact center agent desktop configurations, including the configurations providing users with simultaneous access to multiple ACD systems during a single session. Customized agent desktops are provided as web pages accessible via browser sessions on agent computers. Systems and methods provided herein may be referred to commercially as NovelVox Designer Studio.

A call center agent using systems and methods described herein may begin his/her work shift by initiating a browser session with a web site on a company server, for instance. The web site provides the desktop as a browser session. The desktop contains icons and links for the utilities and data sources the agent needs during his/her shift, including access to multiple ACD systems.

A provider of such customized desktop configurations may remotely build a plurality of different agent desktop using drag and drop tools from within a single application. A technician using the system can select the ACD systems to which a particular agent will have access to. The technician may drag and drop icons for those ACD systems onto a desktop image under construction. The technician can create desktop images for many agents, each agent being provided access to at least two specific ACD systems from their customized desktop. The desktops also provide access to databases and utilities needed by a particular agent to provide service to the customers calling in on the ACD systems to which that agent has been given access. The agent will be able to take live incoming calls during a single session from the at least two ACD systems accessible from his/her desktop.

The agent may be working in a call center environment handling calls from outside customers or fellow employees in technical support center or fulfillment center environments. The agent may be physically located in a call center or may be working from home. Because the desktop and functionality accessible therefrom is provided by a browser session originated by the agent on his/her own computer, the agent need not be physically located in a call center.

Agent access to the at least two ACD systems is via the web server located at the contact center. The web server provides the agent desktop platform via browser session after agents complete authentication. An adapter component is created and stored in the web server. The adapter enables the web server to connect with the ACD systems. The adapter enables incoming calls to the ACD systems to be answered by agents through their browser sessions via the desktop. Systems and methods provided herein build the adapter from application programming interfaces (API) provided by vendors of ACD systems. The adapter provides computer telephony integration (CTI) connectivity to the ACDs and enables agents via their customized desktops to answer calls from the ACD systems.

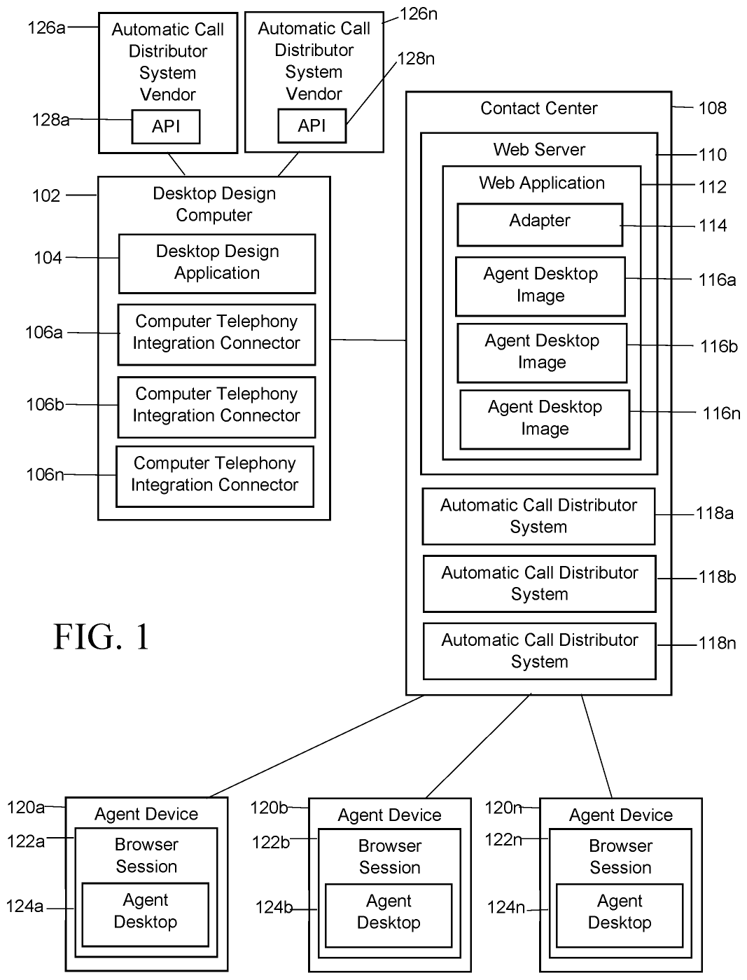

Turning to the figures, FIG. 1 is a block diagram of a system for providing agent desktop access to multiple ACD systems according to an embodiment of the present disclosure. FIG. 1 illustrates components and interactions of a system 100. Components comprise a desktop design computer 102 and a desktop design application 104, referred to hereinafter for brevity as the design computer 102 and the design application 104. The system 100 also comprises computer telephone integration connectors 106a-n, referred to hereinafter for brevity as CTI connectors 106a-n.

The system 100 also comprises a contact center 108, a web server 110, a web application 112, an adapter 114, and agent desktop images 116a-n. The system 100 also comprises automatic call distributor systems 118a-n that may be referred to hereinafter as ACD systems 118a-n.

The system 100 further comprises client devices 120a-n, browser sessions 122a-n, and agent desktops 124a-n. The system 100 also comprises automatic call distributor vendors 126a-n, referred to hereinafter for brevity as ACD vendors 126a-n, and API 128a-n. API is a well-known acronym which stands for application programming interface.

The design computer 102 hosts the design application 104 which builds agent desktop images 116a-n for placement on the web server 110 and access by agent devices 120a-n via browser sessions 122a-n. The design application 104 builds a plurality of different agent desktop images 116a-n depending on what tools (primarily ACD system access) particular call center agents may need to perform their work duties.

The finished agent desktop images 116a-n, when accessed from the web server 110 by the agent devices 120a-n during browser sessions 122a-n, become agent desktops 124a-n. The agent desktops 124a-n are browser session pages that contain links and other objects for accessing ACD systems 118a-n and other resources such as databases.

The design application 104 provides a drag and drop studio environment that helps a company or other organization design its own unique interface for agent desktops 124a-n. A user of the design application 104 is provided the means to create custom agent desktops 124a-n matching the business requirements of the agent's employer and a customer that the employer may be serving. A user of the design application 104 can start with the pre-built agent desktop templates or design and develop fully customized agent desktops 124a-n designed from scratch. A user constructing various agent desktops 124a-n may work entirely or nearly so within the studio environment provided herein and may not need to use or develop any code in customizing desktop.

It is the ability of the design application 104 to enable agent desktops 124a-n to connect with multiple ACDs simultaneously which is not taught by previous implementations. The design application 104 supports many major ACD systems 118a-nof the call center and contact center industry, including Cisco, Avaya, Genesys, Mitel, and Amazon Connect.

In addition to building customer agent desktops 124a-n that can connect with multiple ACD systems 118a-n in a single browser session 122a-n, the design application 104 also creates the adapter 114. The adapter 114 is installed into and executes on the web server 108. The adapter 114 provides computer telephony interface (CTI) functionality to the ACD systems 118a-n. The CTI functionality allows the agent desktops 124a-n to receive voice calls from the ACD systems 118a-n through the web server 110 and web application 112. Without the adapter 114, agent desktops 124a-nwould not be able to connect with multiple ACD systems 118a-n via the web server 110 in a single browser session 122a-n and would not be able to handle incoming voice calls coming from the multiple ACD systems 118a-n.

The design application 104 builds the adapter 114 using APIs 128a-n provided by automatic call distributor system vendors 126a-n. As noted, the design application 104 supports many such ACD vendors 126a-n. The adapter 114 is built in part by CTI connectors 106a-n that the design application 104 creates and stores for use in specific customer configurations that may be needed in the future.

The web server 110 resides in the contact center 108 and hosts the web application 112 that works with the adapter 114. At the beginning of their work shifts, contact center agents using agent devices 120a-n initiate browser sessions 122a-n with the web application 112. The web application 112 accesses a stored agent desktop image 116a-n for each agent device 120a-n and authorizes each particular agent device 120a-n to download its own agent desktop image 116a-n. Different agents may work with different customers who call in on different ACD systems 118a-n so agent desktops 124a-n may differ from one agent to the next, even those located in the same contact center 108.

The web application 112 works with the adapter 114 and the ACD systems 118a-n to provide each agent device 120a-n access to the appropriate ACD system 118a-n. As noted, from one agent to the next agent within a single contact center 108, particular desktop configurations may vary according to the customers that an agent serves. Desktop configurations may also vary based on the experience level of agents as well as permissions to access confidential information, supervisory authority, security clearances held, and other qualifications that may be specific to customer contractual relationships.

While agent desktop images 116a-n and ACD systems 118a-n are shown in FIG. 1 as residing on the web server 110 in the contact center 108, in embodiments agent desktop images 116a-n and ACD systems 118a-n reside elsewhere and are accessed by the web application 112 as needed. Similarly, agent devices 120a-n are not necessarily located on the physical premises of the contact center 108. Some agents may work from home and may log remotely into the web application 112 from their agent device 120a-n.

Systems and methods provided herein promote less needed training and faster onboarding for agents, reducing operational costs. Average handle time for calls may be improved, boosting agent productivity, and promoting increased customer satisfaction.

The design application 114 is a standalone web-based application for agent desktop design, customization, and modification. A technician using the design application 114 may create boards by dragging and dropping designer components of the application 114 on the canvas. The application 114 may integrate with any application having an open API and provides pre-designed, ready-to use templates and boards.

In an embodiment, a system for providing call center agent desktops is provided comprising a computer and an application executing on the computer. The system receives a request from a client device for a desktop image and accesses a stored desktop image for the client device. The system also enables links in the stored image to at least two ACD systems and provides access to the image to the client device. The client device is used by a call center agent responding to incoming calls via desktop ACD access provided by the activated links. The desktop image contains selectable objects providing access to the at least two ACD systems. The at least two ACD systems are provided by unrelated vendors. Access to the at least two ACD systems is provided by at least one adapter executing on the computer, the at least one adapter created from at least two application programming interfaces (API) furnished by providers of the at least two ACD systems.

In another embodiment, a system for providing simultaneous multiple ACD access to call center agents is provide comprising a design computer and a design application executing on the design computer. The system receives a plurality of application programming interfaces (API) provided by a plurality of automatic call distributor (ACD) systems. The system also creates at least one adapter component providing computer telephony integration (CTI) functionality to the plurality of ACD systems. The system also installs the at least one adapter component on a web server.

In yet another embodiment, a method for providing computers in call center environments simultaneous access to multiple unrelated automatic call distributor (ACD) systems is provided. The method comprises a web server receiving installation of an adapter component. The method also comprises the web server accessing, via the adapter component, at least two automatic call distribution (ACD) systems. The method also comprises the web server providing web access to a first client device based on the device initiating a browser session with the web server. The method also comprises the web server providing the first client device incoming call access to the at least two ACD systems via the browser session. The method also comprises the web server receiving the installation of the adapter component from a design computer, the design computer creating the adapter component from application programming interfaces (API). The method also comprises the web server providing in the desktop image selectable objects for user access of the at least two ACD systems and access to additional resources for use in assisting ACD callers.

What is claimed is:

1. A system for providing call center agent desktops, comprising:
a computer; and
an application executing on the computer that:
receives a request from a client device for a desktop image,
accesses a stored desktop image for the client device,
enables links in the stored image to at least two ACD systems, and
provides access to the image to the client device.

2. The system of claim 1, wherein the client device sends the request to the computer via web browser

3. The system of claim 2, wherein the computer in response to the request provides the desktop image in a browser session on the client device.

4. The system of claim 1, wherein the client device is situated in a call center environment

5. The system of claim 4, wherein the client device is used by a call center agent responding to incoming calls via desktop ACD access provided by the activated links.

6. The system of claim 1, wherein the desktop image contains selectable objects providing access to the at least two ACD systems.

7. The system of claim 1, wherein the at least two ACD systems are provided by unrelated vendors.

8. The system of claim 1, wherein access to the at least two ACD systems is provided by at least one adapter executing on the computer, the at least one adapter created from at least two application programming interfaces (API) furnished by providers of the at least two ACD systems.

9. A system for providing simultaneous multiple ACD access to call center agents, comprising:
a design computer; and
a design application executing on the design computer that:
receives a plurality of application programming interfaces (API) provided by a plurality of automatic call distributor (ACD) systems,
creates at least one adapter component providing computer telephony integration (CTI) functionality to the plurality of ACD systems, and
installs the at least one adapter component on a web server.

10. The system of claim 9, wherein the ACD systems are available to client devices via the devices' accessing the web server.

11. The system of claim 10, wherein the client devices access the web server via browser sessions executing on the client devices.

12. The system of claim 11, wherein the web server provides call center agent desktop images to the client devices via the browser sessions.

13. The system of claim 9, wherein a first client device is enabled to access at least two ACD systems via the adapter during a browser session.

14. The system of claim 13, wherein the first client device receives incoming voice calls via the at least two ACD systems during browser sessions.

15. A method for providing computers in call center environments simultaneous access to multiple unrelated automatic call distributor (ACD) systems, comprising:
a web server receiving installation of an adapter component;
the web server accessing, via the adapter component, at least two automatic call distribution (ACD) systems;
the web server providing web access to a first client device based on the device initiating a browser session with the web server; and
the web server providing the first client device incoming call access to the at least two ACD systems via the browser session.

16. The method of claim 15, further comprising the web server receiving the installation of the adapter component from a design computer, the design computer creating the adapter component from application programming interfaces (API).

17. The method of claim 16, wherein the development computer receives the APIs from providers of the at least two ACD systems

18. The method of claim 15, further comprising the web server enabling, via the adapter, the client device to access the at least two ACD systems during a single browser session.

19. The method of claim 18, further comprising the web server providing an agent desktop image to the first client device via the single browser session.

20. The method of claim 19, wherein the web server provides in the desktop image selectable objects for user access of the at least two ACD systems and access to additional resources for use in assisting ACD callers.
